(19) United States
(12) Patent Application Publication
(10) Pub. No.: US 2017/0123716 A1
(43) Pub. Date: May 4, 2017

(54) INTELLIGENT DATA MOVEMENT PREVENTION IN TIERED STORAGE ENVIRONMENTS

(71) Applicant: International Business Machines Corporation, Armonk, NY (US)

(72) Inventors: Derek L. Erdmann, Tucson, AZ (US); David C. Reed, Tucson, AZ (US); Thomas C. Reed, Tucson, AZ (US); Max D. Smith, Tucson, AZ (US)

(73) Assignee: INTERNATIONAL BUSINESS MACHINES CORPORATION, Armonk, NY (US)

(21) Appl. No.: 14/929,359

(22) Filed: Nov. 1, 2015

(51) Int. Cl. G06F 3/06

(52) U.S. Cl. CPC G06F 3/0647; G06F 3/0604; G06F 3/0673; G06F 3/0653

(57) ABSTRACT

A method for preventing unnecessary data movement in a tiered storage environment is disclosed. In one embodiment, such a method migrates a data set from a storage area of a first storage tier to a second storage tier, and makes the storage area available to store other data. The method is further configured to recall the data set from the second storage tier to the first storage tier. When performing such a recall, the method checks whether the storage area has been at least partially overwritten with other data. In the event the storage area has not been at least partially overwritten, the method recovers the data set on the storage area. In the event the storage area has been at least partially overwritten, the method migrates the data set from the second storage tier to the first storage tier. A corresponding system and computer program product are also disclosed.

### BACKGROUND

Field of the Invention

This invention relates to systems and methods for preventing unnecessary data movement in tiered storage environments.

Background of the Invention

In today's tiered storage environments, the “hotness” or “coldness” of data may be continually monitored so that it can be optimally placed on storage media. For example, “hot” (i.e., frequently accessed) data may be placed on faster, more expensive storage media (e.g., solid state drives, faster hard disk drives, etc.) to improve I/O performance. “Cold” (i.e., less frequently accessed) data may be placed on slower, less expensive storage media (e.g., slower hard disk drives, tape, etc.) with reduced I/O performance. As the temperature of the data changes, the data may be migrated between storage tiers to optimize I/O performance. DFSMShsm is one example of a software component configured to manage and migrate data between tiers of a tiered storage environment.

In current DFSMShsm implementations, after a data set has been migrated from a primary volume residing on faster, more expensive storage media, to a migration volume residing on slower, less expensive storage media, DFSMShsm will delete data set control blocks (DSCBs) associated with the data set from the primary volume. However, storage space (e.g., extents) used to store the data set on the primary volume may remain unaltered until the storage space is overwritten with other data. When a user or application attempts to access the data set, DFSMShsm will attempt to recall (i.e., move) the data set from the migration volume to the primary volume. This process may require creating new DSCBs on the primary volume in addition to moving the data set from the migration volume to the primary volume, even if the storage space formerly used to store the data set on the primary volume remains unaltered.

In view of the foregoing, what are needed are systems and methods to prevent unnecessary data movement in tiered storage environments. Ideally, such systems and methods will enable data to be recovered on storage areas where data has been migrated but not yet overwritten.

### SUMMARY

The invention has been developed in response to the present state of the art and, in particular, in response to the problems and needs in the art that have not yet been fully solved by currently available systems and methods. Accordingly, the invention has been developed to provide systems and methods to prevent unnecessary data movement in tiered storage environments. The features and advantages of the invention will become more fully apparent from the following description and appended claims, or may be learned by practice of the invention as set forth hereinafter.

Consistent with the foregoing, a method for preventing unnecessary data movement in a tiered storage environment is disclosed herein. In one embodiment, such a method migrates a data set from a storage area of a first storage tier to a second storage tier, and makes the storage area available to store other data. The method is further configured to recall the data set from the second storage tier to the first storage tier. When performing such a recall, the method checks whether the storage area has been at least partially overwritten with other data. In the event the storage area has not been at least partially overwritten, the method recovers the data set on the storage area. In the event the storage area has been at least partially overwritten, the method migrates the data set from the second storage tier to the first storage tier.

A corresponding system and computer program product are also disclosed and claimed herein.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a high-level block diagram showing one example of a network environment that may provide multiple storage tiers;

FIG. 2 is a high-level block diagram showing one example of a storage system that may provide multiple storage tiers;

FIG. 3 is a high-level block diagram showing one example of a tiered storage where data is moved between primary volumes and migration volumes;

FIG. 4 is a high-level block diagram showing one example of data structures used to prevent unnecessary data movement in a tiered storage environment;

FIG. 5 is a high-level block diagram showing another example of data structures used to prevent unnecessary data movement in a tiered storage environment;

FIG. 6 is a flow diagram showing one embodiment of a method for migrating a data set using the data structures discussed in association with FIG. 4;

FIG. 7 is a flow diagram showing one embodiment of a method for allocating a new data set using the data structures discussed in association with FIG. 4; and

FIG. 8 is a flow diagram showing one embodiment of a method for recalling a data set using the data structures discussed in association with FIG. 4.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

The present invention may be embodied as a system, method, and/or computer program product. The computer program product may include a computer readable storage medium (or media) having computer readable program instructions thereon for causing a processor to carry out aspects of the present invention.

The computer readable storage medium may be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer-readable program instructions for carrying out operations of the present invention may be assembler instructions, instruction-set-architecture (ISA) instructions, machine instructions, machine-dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages.

The computer readable program instructions may execute entirely on a user's computer, partly on a user's computer, as a stand-alone software package, partly on a user's computer and partly on a remote computer, or entirely on a remote computer or server. In the latter scenario, a remote computer may be connected to a user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, may be implemented by computer-readable program instructions.

These computer-readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block or blocks.

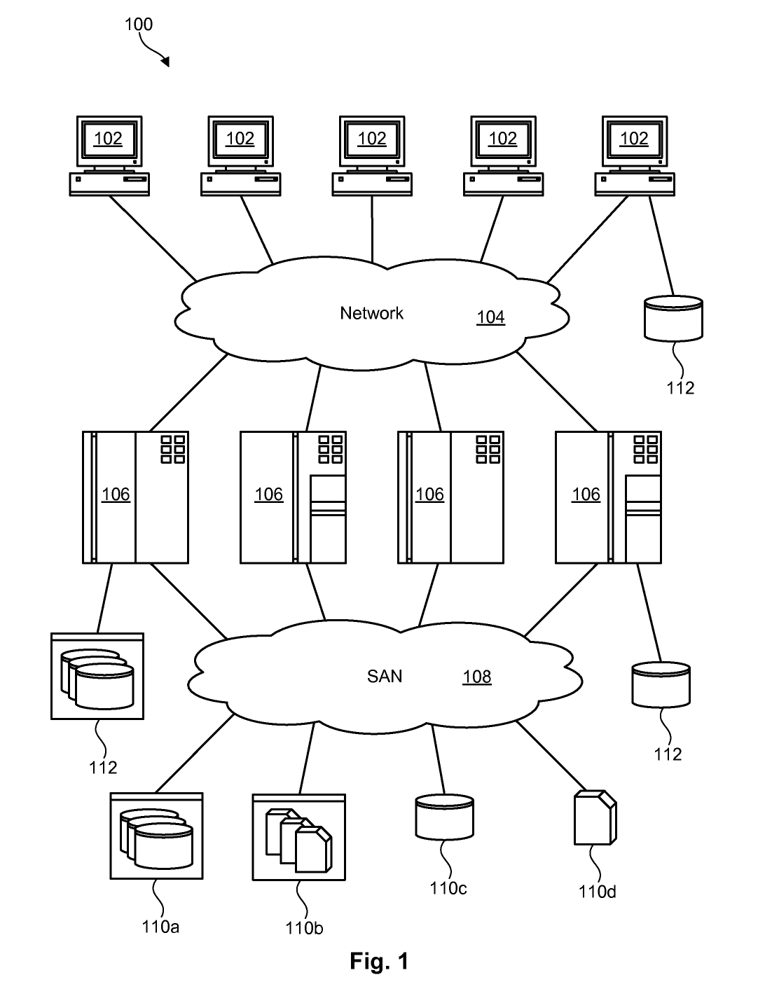

Referring to FIG. 1, one example of a network environment 100 is illustrated. The network environment 100 is presented to show one example of an environment that may provide multiple storage tiers. The network environment 100 is presented only by way of example and not limitation. Indeed, the apparatus and methods disclosed herein may be applicable to a wide variety of network environments, in addition to the network environment 100 shown.

As shown, the network environment 100 includes one or more computers 102, 106 interconnected by a network 104. The network 104 may include, for example, a local-area-network (LAN) 104, a wide-area-network (WAN) 104, the Internet 104, an intranet 104, or the like. In certain embodiments, the computers 102, 106 may include both client computers 102 and server computers 106 (also referred to herein as “host systems” 106). In general, the client computers 102 initiate communication sessions, whereas the server computers 106 wait for requests from the client computers 102. In certain embodiments, the computers 102 and/or servers 106 may connect to one or more internal or external direct-attached storage systems 112 (e.g., arrays of hard-disk drives, solid-state drives, tape drives, etc.). These computers 102, 106 and direct-attached storage systems 112 may communicate using protocols such as ATA, SATA, SCSI, SAS, Fibre Channel, or the like. One or more of the storage systems 112 may provide one or more storage tiers in a tiered storage environment.

The network environment 100 may, in certain embodiments, include a storage network 108 behind the servers 106, such as a storage-area-network (SAN) 108 or a LAN 108 (e.g., when using network-attached storage). This network 108 may connect the servers 106 to one or more storage systems 110, such as arrays 110a of hard-disk drives or solid-state drives, tape libraries 110b, individual hard-disk drives 110c or solid-state drives 110c, tape drives 110d, CD-ROM libraries, or the like. To access a storage system 110, a host system 106 may communicate over physical connections from one or more ports on the host 106 to one or more ports on the storage system 110. A connection may be through a switch, fabric, direct connection, or the like. In certain embodiments, the servers 106 and storage systems 110 may communicate using a networking standard such as Fibre Channel (FC). One or more of the storage systems 110 may provide one or more storage tiers in a tiered storage environment.

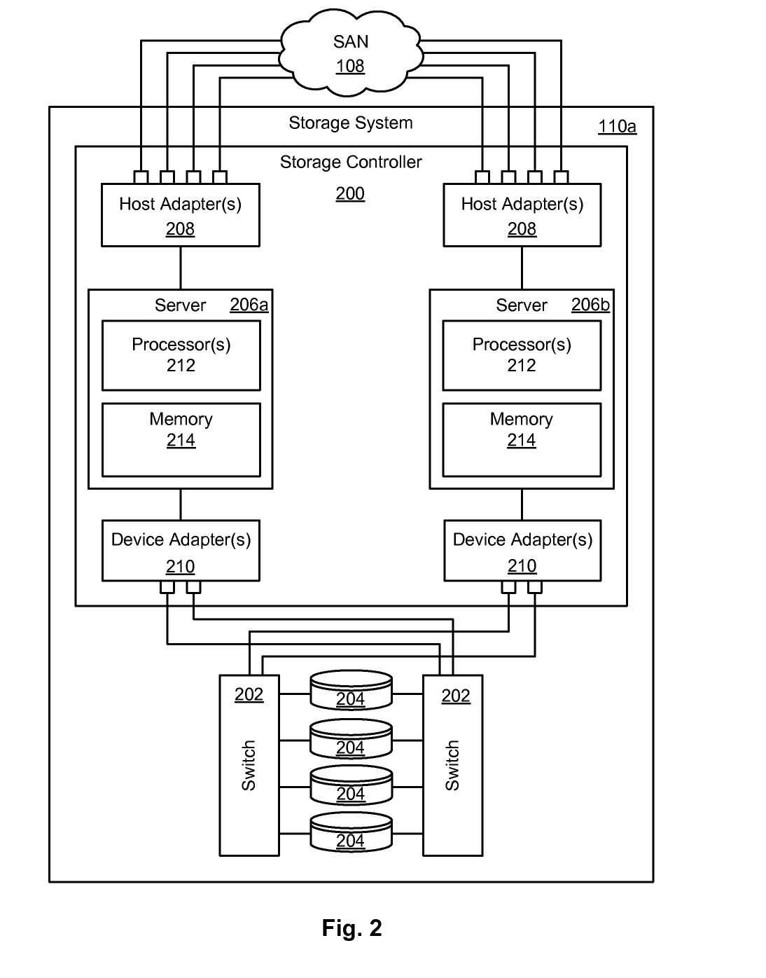

Referring to FIG. 2, one embodiment of a storage system 110a containing an array of hard-disk drives 204 and/or solid-state drives 204 is illustrated. The internal components of the storage system 110a are shown since tiered storage may, in certain embodiments, be implemented within such a storage system 110a. As shown, the storage system 110a includes a storage controller 200, one or more switches 202, and one or more storage devices 204, such as hard disk drives 204 or solid-state drives 204 (such as flash-memory-based drives 204). The storage controller 200 may enable one or more hosts 106 (e.g., open system and/or mainframe servers 106) to access data in the one or more storage devices 204.

In selected embodiments, the storage controller 200 includes one or more servers 206. The storage controller 200 may also include host adapters 208 and device adapters 210 to connect the storage controller 200 to host devices 106 and storage devices 204, respectively. Multiple servers 206a, 206b may provide redundancy to ensure that data is always available to connected hosts 106. Thus, when one server 206a fails, the other server 206b may pick up the I/O load of the failed server 206a to ensure that I/O is able to continue between the hosts 106 and the storage devices 204. This process may be referred to as a “failover.”

One example of a storage system 110a having an architecture similar to that illustrated in FIG. 2 is the IBM DS8000™ enterprise storage system. The DS8000™ is a high-performance, high-capacity storage controller providing disk storage that is designed to support continuous operations. Nevertheless, the apparatus and methods disclosed herein are not limited to the IBM DS8000™ enterprise storage system 110a, but may be implemented in any comparable or analogous storage system 110, regardless of the manufacturer, product name, or components or component names associated with the system 110. Furthermore, any storage system that could benefit from one or more embodiments of the invention is deemed to fall within the scope of the invention. Thus, the IBM DS8000™ is presented only by way of example and is not intended to be limiting.

In selected embodiments, each server 206 may include one or more processors 212 and memory 214. The memory 214 may include volatile memory (e.g., RAM) as well as non-volatile memory (e.g., ROM, EPROM, EEPROM, hard disks, flash memory, etc.). The volatile and non-volatile memory may, in certain embodiments, store software modules that run on the processor(s) 212 and are used to access data in the storage devices 204. The servers 206 may host at least one instance of these software modules. These software modules may manage all read and write requests to logical volumes in the storage devices 204.

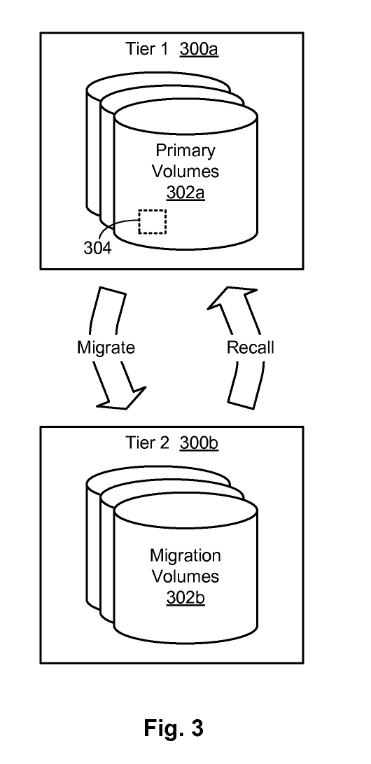

Referring to FIG. 3, as mentioned above, the network environment 100 and/or storage system 110 may be configured to provide tiered data storage. In such a system, the “hotness” or “coldness” of data may be continually monitored so that it can be optimally placed on different tiers 300. For example, faster storage devices (e.g., solid state drives, faster hard disk drives, etc.) may make up a first tier 300a, while slower storage devices (e.g., slower hard disk drives, tape, etc.) may make up a second tier 300b. “Hot” (i.e., frequently accessed) data may be placed on the first tier 300a to improve I/O performance, while “cold” (i.e., less frequently accessed) data may be placed on the second tier 300b. As the temperature of the data changes, the data may be migrated between the storage tiers 300a, 300b to optimize I/O performance. The storage tiers 300a, 300b may be implemented within a single storage system 110 or potentially distributed across multiple storage systems 110. Additional tiers 300 may be provided where needed. The example described above is provided only by way of example and not limitation.

As previously discussed herein, DFSMShsm is one example of a software component configured to manage and migrate data between tiers 300 of a tiered storage environment. In current DFSMShsm implementations, after a data set has been migrated from a primary volume 302a in a first storage tier 300a to a migration volume 302b in a second storage tier 300b, DFSMShsm will delete data set control blocks (DSCBs) associated with the data set from the primary volume 302a. However, storage space 304 (i.e., extents) used to store the data set on the primary volume 302a may remain unaltered until the storage space 304 is actually overwritten with other data. When a user or application attempts to access the data set, DFSMShsm will attempt to recall (i.e., move) the data set from the migration volume 302b to the primary volume 302a. This process may require creating new DSCBs on the primary volume 302a in addition to moving the data set from the migration volume 302b to the primary volume 302a, even if the storage space 304 formerly used to store the data set on the primary volume 302a remains unaltered.

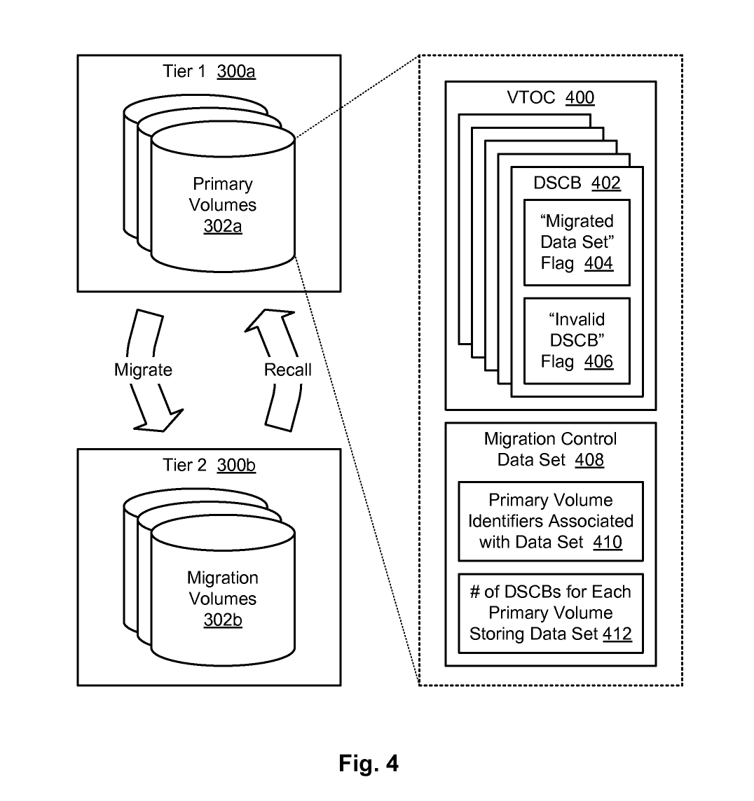

Referring to FIG. 4, in order to prevent unnecessary data movement in a tiered storage environment, various data structure may be established. For example, in one embodiment, each of the DSCBs 402 associated with a data set on a primary volume 302a may be configured with a “migrated data set” flag 404 and an “invalid DSCB” flag 406. These DSCBs 402 may, in certain embodiments, be stored in the volume table of contents 400 (VTOC) of the primary volume(s) 302a on which the data set resides. Similarly, a migration control data set 408 (used by DFSMShsm) may be configured to record primary volume identifiers 410 (e.g., volume serial numbers) that are associated with a particular data set as well as a number 412 of DSCBs 402 for each primary volume 302a storing the data set. In general, the migration control data set (MCDS) 408 may contain information about migrated data sets and the volumes 302 they migrate to and from. DFSMShsm may use this information to manage data sets and associated volumes 302.

When a data set is migrated from one or more primary volumes 302a to one or more migration volumes 302b, the “migrated data set” flag 404 in each DSCB 402 associated with the data set may be set (e.g., changed from “0” to “1”), thereby indicating that the associated data set has been migrated. In addition, the migration control data set 408 may be modified or updated to record the primary volumes identifiers 410 that are associated with the migrated data set as well as a count 412 of DSCBs 402 for each primary volume 302a storing the data set.

When a new data set is allocated on (or moved to) storage space 304 previously occupied by the migrated data set, the “invalid DSCB” flag 406 for each DSCB 402 associated with the overwritten storage space 304 may be set (e.g., changed from “0” to “1”). to indicate that the associated DSCB 402 is invalid. In such cases, the previously stored data will not be recoverable since all or part of it has been overwritten on the primary volumes 302a.

When a migrated data set is recalled from the migration volumes 302b to the primary volumes 302a, the primary volume identifiers 410 and counts 412 of DSCBs 402 for each primary volume 302a stored in the migration control data set 408 may be compared to the actual primary volumes 302a and count of DSCBs 402 on the primary volumes 302a. If these numbers do not match, then the storage space 304 previously used to store the migrated data set was possibly overwritten and the data set cannot be recovered on the primary volumes 302a. In such case, DSCBs 402 that are associated with the data set and stored on the primary volumes 302a may be deleted and the data set may be moved from the migration volumes 302b to the primary volumes 302a in the conventional manner, including the generation of new DSCBs 402 on the primary volumes 302a. Additionally, or alternatively, if any of the DSCBs 402 on the primary volumes 302a associated with the migrated data set have their “invalid DSCB” flag 406 set, this may also indicate that all or part of the associated data set has been overwritten. In such case, DSCBs 402 that are associated with the data set and stored on the primary volumes 302a may be deleted and the data set may be moved from the migration volumes 302b to the primary volumes 302a in the conventional manner.

If, on the other hand, the primary volume identifiers 410 and counts 412 in the migration control data set 408 match those actually found on the primary volumes 302a, and none of the “invalid DSCB” flags 406 associated with the migrated data set are set, this may indicate that the storage space 304 previously used to store the data set was not overwritten. In such case, the data set may be recovered on the primary volumes 302a. No data movement is necessary. In such a case, the “migrated data set” flags 404 for DSCBs 402 on the primary volumes 302a associated with the data set may be reset (e.g., changed from “1” to “0”) to indicate that the data set is present on the primary volumes 302a and represents valid data.

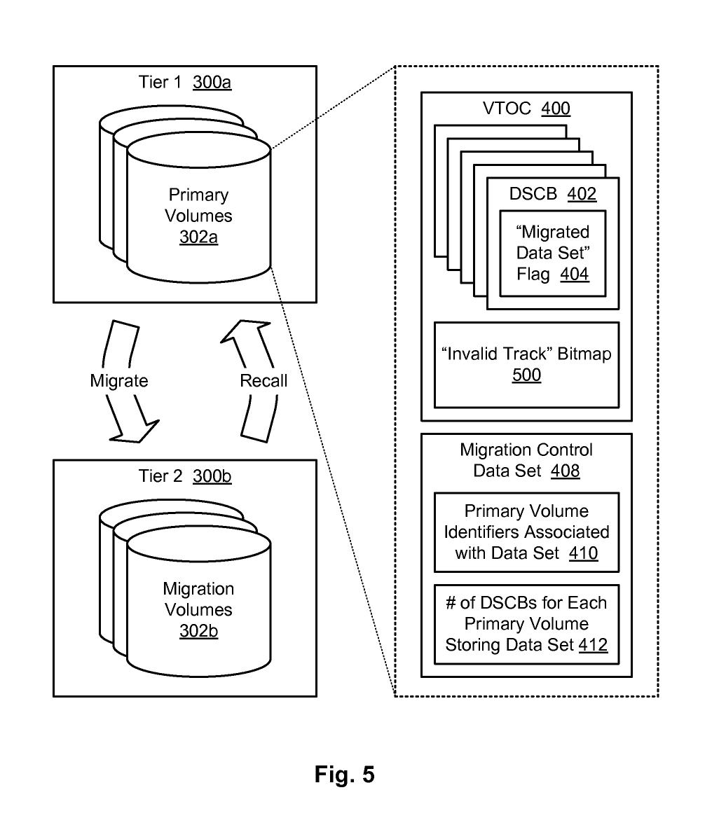

Referring to FIG. 5, another example of data structures used to prevent unnecessary data movement in a tiered storage environment is illustrated. In this embodiment, an “invalid track” bitmap 500 is used in place of the “invalid DSCB” flags 406 previously discussed. The “invalid track” bitmap 500 may serve much the same function as the “invalid DSCB” flags 406. In this embodiment, the “invalid track” bitmap 500 may be maintained for a primary volume 302a and include a bit for each track in the primary volume 302a. In certain embodiments, the “invalid track” bitmap 500 may be stored in the VTOC 400 of the primary volume 302a, although this is not mandatory.

When a data set is migrated from storage space 304 on a primary volume 302a to one or more migration volumes 302b, the “invalid track” bitmap 500 may be modified to indicate which tracks have been overwritten on the primary volume 302a. If, when recalling the data set from the one or more migration volumes 302b to the primary volume 302a, any tracks of the original storage space 304 have been overwritten, the data set may not be recoverable on the primary volume 302a. In such case, the DSCBs 402 associated with the data set on the primary volume 302a may be deleted and the data set may be moved from the one or more migration volumes 302b to the primary volume 302a in the conventional manner. If, on the other hand, none of the tracks of the original storage space 304 have been overwritten (and the primary volume identifiers 410 and counts 412 match the actual primary volumes 302a and DSCBs 402 associated with the data set), then the data set may be recoverable on the primary volume 302a. In such case, the “migrated data set” flags 404 of the DSCBs 402 associated with the data set may be reset to indicate that the data set is now located on the primary volume 302a and represents valid data.

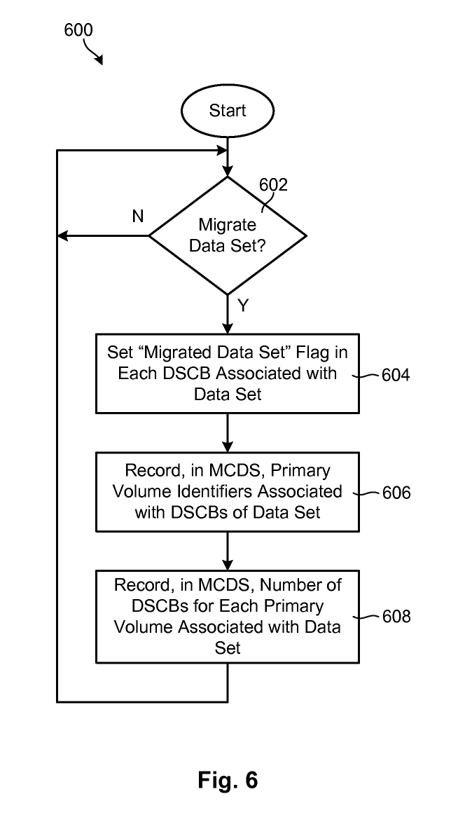

Referring to FIG. 6, one embodiment of a method 600 for migrating a data set from one or more primary volumes 302a to one or more migration volumes 302b is illustrated. Such a method 600 uses the new data structures described in association with FIG. 4. The method 600 may also be modified to work with the data structures discussed in association with FIG. 5.

As shown, the method 600 determines 602 whether a data set is to be migrated from one or more primary volumes 302a to one or more migration volumes 302b. If the data set is to be migrated, the method 600 sets 604 the “migrated data set” flag 404 for each DSCB 402 associated with the data set. The method 600 also records 606, in the migration control data set 408, primary volume identifiers 410 for each primary volume 302a associated with the data set. The method 600 also records, in the migration control data set 408, a count 412 of DSCBs 402 in each primary volume 302a associated with the data set.

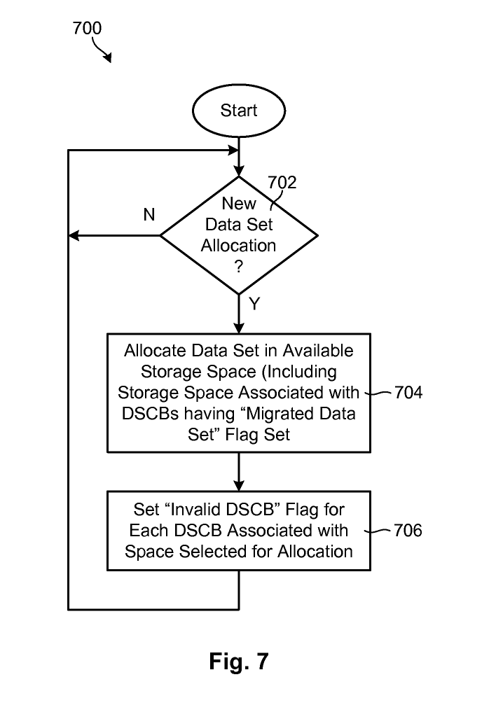

Referring to FIG. 7, one embodiment of a method 700 for allocating a new data set (or moving an existing data set) to a primary volume 302a is illustrated. Such a method 700 also uses the new data structures described in association with FIG. 4. However, the method 700 may also be modified to work with the data structures discussed in association with FIG. 5.

As shown, the method 700 initially determines 702 whether a new data set is to be allocated on the primary volumes 302a. If so, the method 700 allocates 704 the data set in available storage space on the primary volumes 302a. This available storage space may include storage space 304 previously occupied by a migrated data set and associated with one or more DSCBs 402 having their “migrated data set” flags 404 set. If the new data set is allocated on storage space 304 associated with DSCBs 402 having their “migrated data set” flags 404 set, the method 700 sets the “invalid DSCB” flags 406 for each of these DSCBs 402. Alternatively, if the data structures disclosed in FIG. 5 are used, the method 700 may modify the “invalid track” bitmap 500 to reflect tracks that are overwritten by the newly allocated data set.

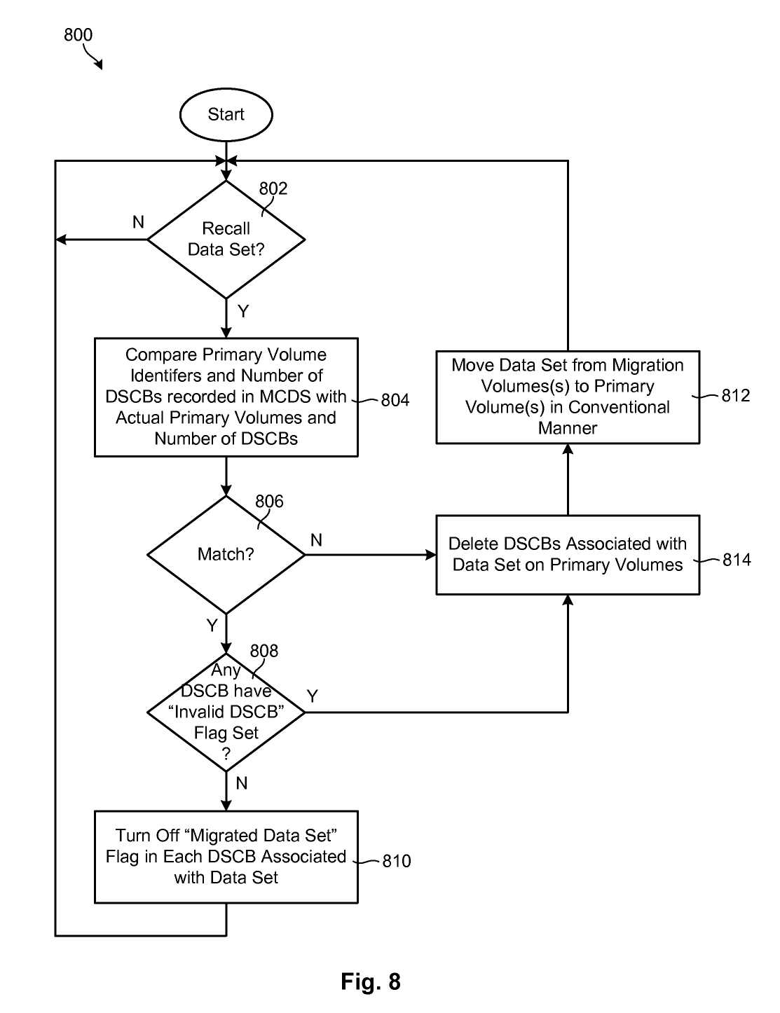

Referring to FIG. 8, one embodiment of a method 800 for recalling a data set from one or more migration volumes 302b to one or more primary volumes 302a is illustrated. Such a method 800 also uses the new data structures described in association with FIG. 4. However, the method 800 may be modified to work with the data structures discussed in association with FIG. 5.

As shown, the method 800 initially determines 802 whether a data set is to be recalled from one or more migration volumes 302b to one or more primary volumes 302a. If so, the method 800 compares 804 the primary volume identifiers 410 and count 412 of DSCBs 402 for each primary volume 302a recorded in the migration control data set 408 with the actual primary volumes 302a and DSCBs 402 on the primary volumes 302a. If, at step 806, this information does not match, then the data set that is being recalled was likely all or partially overwritten on the primary volumes 302a and is thus unrecoverable. In such case, the method 800 deletes 814 the DSCBs 402 associated with the data set from the primary volumes 302a, and moves 812 the data set from the migration volume(s) 302b to the primary volume(s) 302a in the conventional manner, including the creation of new DSCBs 402 on the primary volume(s) 302a.

If, at step 806, the information 410, 412 in the migration control data set 408 and the information on the primary volumes 302a match, the method 800 determines 808 whether any DSCBs 402 associated with the data set being recalled have their “invalid DSCB” flags 406 set. If so, the data set that is being recalled is likely all or partially overwritten and thus unrecoverable on the primary volumes 302a. In such case, the method 800 deletes 814 the DSCBs 402 associated with the data set from the primary volumes 302a, and moves 812 the data set from the migration volume(s) 302b to the primary volume(s) 302a in the conventional manner.

If, at step 806, the information 410, 412 in the migration control data set 408 matches information on the primary volumes 302a for the data set being recalled and, at step 808, none of the “invalid DSCB” flags 406 for DSCBs 402 associated with the recalled data set are set, then the data set is recoverable on the primary volume(s) 302a and the method 800 turns off 810 (i.e., resets) the “migrated data set” flag 404 in each DSCB 402 associated with the recalled data set. This restores the data set on the primary volume(s) 302a and reduces recall time. No data movement is necessary. The larger the data set, the more time that is saved.

As there will be DSCBs 402 on primary volumes 302 as that are associated with migrated datasets, if the migrated datasets are deleted (either via command or automatically), in addition to normal DFSMShsm deletion processing, the DSCBs 402 will also be deleted as they are no longer needed.

The data structures described in FIGS. 4 and 5 are provided by way of example and not limitation. Other data structures for keeping track of migrated data sets and whether original data remains unaltered on primary volumes 302a (thereby allowing the data to be restored and preventing unnecessary data movement) are possible and within the scope of the invention. Any data structures used to perform this function are deemed to fall within the scope of the invention. Furthermore, although the data structures described herein have been discussed primarily in association with DFSMShsm, the data structures are not limited to use by DFSMShsm but may be used with any other analogous or comparable tiered storage management or data migration software or component.

The flowcharts and block diagrams in the Figures illustrate the architecture, functionality, and operation of possible implementations of systems, methods, and computer-usable media according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

1. A method to prevent unnecessary data movement in a tiered storage environment, the method comprising:
migrating a data set from a storage area of a first storage tier to a second storage tier;
making the storage area available to store other data;
recalling the data set from the second storage tier to the first storage tier;
checking whether the storage area has been at least partially overwritten with other data;
in the event the storage area has not been at least partially overwritten, recovering the data set on the storage area; and
in the event the storage area has been at least partially overwritten, migrating the data set from the second storage tier to the first storage tier.

2. The method of claim 1, wherein migrating the data set from the storage area comprises setting a “migrated data set” flag for each data set control block (DSCB) associated with the data set.

3. The method of claim 1, wherein migrating the data set from the storage area further comprises recording, in a migration control data set (MCDS), which primary volumes on the first storage tier contain DSCBs associated with the data set.

4. The method of claim 3, wherein checking whether the storage area has been at least partially overwritten further comprises checking whether a number of DSCBs recorded in the MCDS for the data set matches a number of DSCBs for the data set on the primary volumes.

5. The method of claim 1, wherein checking whether the storage area has been at least partially overwritten further comprises checking whether an “invalid DSCB” flag is set for any DSCB associated with the data set.

6. The method of claim 1, wherein checking whether the storage area has been at least partially overwritten further comprises scanning the DSCBs of the data set to determine which tracks of the first storage tier the data set is written to.

7. The method of claim 6, wherein checking whether the storage area has been at least partially overwritten further comprises examining a bitmap to determine whether any of the tracks have been overwritten.

8. A computer program product to prevent unnecessary data movement in a tiered storage environment, the computer program product comprising a computer-readable storage medium having computer-usable program code embodied therein, the computer-usable program code comprising:
computer-usable program code to migrate a data set from a storage area of a first storage tier to a second storage tier;
computer-usable program code to make the storage area available to store other data;
computer-usable program code to recall the data set from the second storage tier to the first storage tier;
computer-usable program code to check whether the storage area has been at least partially overwritten with other data;
computer-usable program code to, in the event the storage area has not been at least partially overwritten, recover the data set on the storage area; and
computer-usable program code to, in the event the storage area has been at least partially overwritten, migrate the data set from the second storage tier to the first storage tier.

9. The computer program product of claim 8, wherein migrating the data set from the storage area comprises setting a “migrated data set” flag for each data set control block (DSCB) associated with the data set.

10. The computer program product of claim 8, wherein migrating the data set from the storage area further comprises recording, in a migration control data set (MCDS), which primary volumes on the first storage tier contain DSCBs associated with the data set.

11. The computer program product of claim 10, wherein checking whether the storage area has been at least partially overwritten further comprises checking whether a number of DSCBs recorded in the MCDS for the data set matches a number of DSCBs for the data set on the primary volumes.

12. The computer program product of claim 8, wherein checking whether the storage area has been at least partially overwritten further comprises checking whether an “invalid DSCB” flag is set for any DSCB associated with the data set.

13. The computer program product of claim 8, wherein checking whether the storage area has been at least partially overwritten further comprises scanning the DSCBs of the data set to determine which tracks of the first storage tier the data set is written to.

14. The computer program product of claim 13, wherein checking whether the storage area has been at least partially overwritten further comprises examining a bitmap to determine whether any of the tracks have been overwritten.

15. A system to prevent unnecessary data movement in a tiered storage environment, the system comprising:
at least one processor;
at least one memory device operably coupled to the at least one processor and storing instructions for execution on the at least one processor, the instructions causing the at least one processor to:
migrate a data set from a storage area of a first storage tier to a second storage tier;
make the storage area available to store other data;
recall the data set from the second storage tier to the first storage tier;
check whether the storage area has been at least partially overwritten with other data;
in the event the storage area has not been at least partially overwritten, recover the data set on the storage area; and
in the event the storage area has been at least partially overwritten, migrate the data set from the second storage tier to the first storage tier.

16. The system of claim 15, wherein migrating the data set from the storage area comprises setting a “migrated data set” flag for each data set control block (DSCB) associated with the data set.

17. The system of claim 15, wherein migrating the data set from the storage area further comprises recording, in a migration control data set (MCDS), which primary volumes on the first storage tier contain DSCBs associated with the data set.

18. The system of claim 17, wherein checking whether the storage area has been at least partially overwritten further comprises checking whether a number of DSCBs recorded in the MCDS for the data set matches a number of DSCBs for the data set on the primary volumes.

19. The system of claim 15, wherein checking whether the storage area has been at least partially overwritten further comprises checking whether an “invalid DSCB” flag is set for any DSCB associated with the data set.

20. The system of claim 15, wherein checking whether the storage area has been at least partially overwritten further comprises scanning the DSCBs of the data set to determine which tracks of the first storage tier the data set is written to, and examining a bitmap to determine whether any of the tracks have been overwritten.
